(19) United States
(12) Patent Application Publication
(10) Pub. No.: US 2026/0044665 A1
(43) Pub. Date: Feb. 12, 2026

(54) METHOD AND A SYSTEM FOR RENDERING WEB CONTENT

(71) Applicant: Y.E. Hub Armenia LLC, Yerevan (AM)

(72) Inventors: Vadim PETROV, Moscow (RU); Maxim SMIRNOV, Moscow (RU)

(21) Appl. No.: 19/235,034

(22) Filed: Jun. 11, 2025

(30) Foreign Application Priority Data
Aug. 8, 2024 (RU) 2024122798

(51) Int. Cl. G06F 40/14; G06T 1/20

(52) U.S. Cl. CPC G06F 40/14; G06T 1/20

(57) ABSTRACT

A method and an electronic device for rendering web content in a browser application are provided. The method comprises: receiving a given web content to be rendered in the browser application; executing a first rendering phase, during which the browser application is configured to: render the given web content by using currently available computational resources of a central processing unit (CPU); and initialize a graphics processing unit (GPU) for rendering the given content; in response to receiving an indication of the GPU having been initialized, executing a second rendering phase following the first rendering phase, during which the browser application is configured to: execute a hot switch from the rendering the given content using the CPU to rendering the given content of the given webpage using the GPU, thereby continue rendering the given content; and display the rendered given content on a screen of the electronic device.

### CROSS-REFERENCE

The present application claims priority to Russian Patent Application No. 2024122798, entitled “Method and a System for Rendering Web Content”, filed Aug. 8, 2024, the entirety of which is incorporated herein by reference.

### FIELD

The present technology relates generally to web browsing; and in particular, to a method of and system for rendering web content in a browser application.

### BACKGROUND

To render web content of a given web page onto a screen of an electronic device of a user, a browser application (for example, a Yandex.Browser™ browser application, a Google Chrome™ browser application, an Opera™ browser application, and the like) includes a specific component, called “rendering engine,” which is configured to execute rendering instructions and cause hardware components of the electronic device, such as random-access memory (RAM), graphics processing unit (GPU), and others, to download the web content and cause the respective pixels on the screen of the electronic device to light up.

Some architectures of browser applications, such as a Chromium™ browser architecture, utilize a GPU-based rendering engines that are configured to use the computational resources of the GPU for rendering the web content of the given web page.

However, using such rendering engines may be computationally inefficient, as initializing the GPU may require significant time causing user-perceivable delays of the user between the moments of submitting a Universal Resource Locator (URL) address of the given web page to an address bar of the browser application and having the web content rendered on the screen of the electronic device. This may affect the user experience of the user with the browser application.

Certain prior art approaches have been proposed to tackle the above-identified technical problem.

U.S. Pat. No. 8,988,434-B1, issued on Mar. 24, 2015, assigned to Google LLC, and entitled “TEXT RENDERING FOR BROWSERS AND MOBILE BASED APPLICATIONS,” discloses a system and method for rendering text data in web applications that eliminates redundant processing. Constant resources are pre-computed and work is offloaded from the central processing unit to the graphics processing unit. This is generally accomplished by pre-computing before any rendering. A generic index vertex buffer object is created, and for each font, a glyph texture object and glyph position texture object are created. A frame including text is then rendered in which a glyph string texture object is created. For each character, a glyph index-to-texture and glyph offset to-texture is appended. A glyph texture, glyph position texture and glyph string texture are then bound, and the generic index vertex buffer object using a custom vertex shader is rendered.

U.S. Pat. No. 10,223,997-B2, issued on March 5, 20219, assigned to Ubitus KK, and entitled “SYSTEM AND METHOD OF LEVERAGING GPU RESOURCES TO INCREASE PERFORMANCE OF AN INTERACT-ABLE CONTENT BROWSING SERVICE,” discloses a system and a corresponding method of leveraging GPU resources to increase performance of the interactable content browsing (ICB) service that are to utilize the computation capacity of the GPU of the graphics card to share the computation load originally taken by the CPU. The raw images depicted by the browser application program executed in the server can be directly retrieved from the VRAM of the graphics card by the encoder inside the GPU to be further encoded and streamed before being forwarded directly to distant clients. Thereby, work load and bus bandwidth occupation on the CPU can be greatly reduced, the number of clients that can be served simultaneously by a single server can be increased, and the related power consumption can be substantially reduced.

### SUMMARY

Therefore, there is a need for systems and methods which avoid, reduce or overcome the limitations of the prior art.

Developers of the present technology have appreciated that the efficiency of the Chromium™-based browser application can be increased if there were two independent rendering pipelines defined within the architecture of the browser application. A first rendering pipeline could be configured for rendering the web content using computational resources of a central processing unit (CPU) of the electronic device; and a second rendering pipeline could be configured for rendering the web content using computational resources of the GPU of the electronic device.

Thus, the browser application could be configured to start rendering the web content on the screen of the electronic device by executing the first rendering pipeline, that is, using the computational resources of the CPU; causing initialization of the GPU at the same time for further execution of the second rendering pipeline. Once the browser application has received an indication of the GPU being fully initialized and ready for rendering the web content, according to at least some non-limiting embodiments of the present technology, the browser application can be configured to execute a hot switch from the first rendering pipeline to the second pipeline and continue rendering the web content using the computational resources of the GPU.

By doing so, in at least some non-limiting embodiments of the present technology, the browser application can be configured to start rendering “lighter” components (such as texts and hyperlinks, for example) of the web content using the resources of CPU, while at the same time, preparing the GPU for rendering “heavier” components (such as certain applications, audio and video files, and high-definition images, for example). Such an approach may be especially effective during a so-called “cold start” of the browser application, that is, a first launch of the browser application after a reboot of an operating system controlling the electronic device. More specifically, during the cold start, as will be described in detail below, the present methods and systems may allow rendering graphical user interface (GUI) components the browser application using the first rendering pipeline while causing initialization of the GPU, and once the GPU is initialized, the second rendering pipeline can be executed for rendering web content of webpages requested by the user.

This may allow more effectively utilizing the computational resources of the electronic device, preventing the user-perceivable “glitches” on the screen when browsing the web content, which may improve the user experience of the user from interacting with the browser application.

More specifically, in accordance with a first broad aspect of the present technology, there is provided a computer-implemented method for rendering web content in a browser application. The browser application is executed by an electronic device comprising a central processing unit (CPU) and a graphics processing unit (GPU). The browser application has: (i) a first rendering pipeline for rendering the web content using the CPU, and (ii) a second rendering pipeline for rendering the web content using the GPU. The method comprises: receiving, from a web server associated with a given webpage, a given web content to be rendered thereon in the browser application; executing a first rendering phase, during which the browser application is configured to: render the given web content by executing the first rendering pipeline using currently available computational resources of the CPU; and initialize the GPU for rendering the given content; in response to receiving an indication of the GPU having been initialized, executing a second rendering phase following the first rendering phase, during which the browser application is configured to: execute a hot switch from the first rendering pipeline to the second rendering pipeline to continue rendering the given content of the given webpage using the GPU; and display the given webpage with the given content rendered thereon on a screen of the electronic device.

In some implementations of the method, to render the given web content by executing the first rendering pipeline, the browser application is configured to initialize the CPU for the rendering by uploading a first set of instructions therefor to a random-access memory (RAM) of the electronic device, the first set of instructions being able to be uploaded to the RAM over a first period; and to initialize the GPU, the browser application is configured to upload a second set of instructions for the GPU to the RAM of the electronic device, the second set of instructions being able to be uploaded to the RAM over a second period, greater than the first period.

In some implementations of the method, the first set of instructions is smaller in size than the second set of instructions.

In some implementations of the method, the second set of instructions comprises instructions to initialize a context of the GPU.

In some implementations of the method, to execute the host switch, the browser application is configured to abort executing the first rendering pipeline.

In some implementations of the method, to abort executing the first rendering pipeline, the browser application is configured to unload the first set of instructions from the RAM of the electronic device.

In some implementations of the method, the browser architecture of the browser application is based on a Chromium browser architecture.

In some implementations of the method, the method is executed during a cold start of the browser application.

In some implementations of the method, the executing the first rendering pipeline comprises causing an operating system (OS) of the electronic device to execute a first operating system (OS) process; and the executing the second rendering pipeline comprises causing the OS of the electronic device to execute a second OS process, different from the first OS process.

In some implementations of the method, to execute the hot switch, the browser application is configured to cause the operating system to end the first OS process and run the second OS process.

Further, in accordance with a second broad aspect of the present technology, there is provide an electronic device for rendering web content in a browser application. The browser application is executed by the electronic device. The electronic device comprises: at least one central processing unit (CPU) and a graphics processing unit (GPU). The browser application has: (i) a first rendering pipeline for rendering the web content using the at least one CPU, and (ii) a second rendering pipeline for rendering the web content using the GPU. The electronic device further comprises at least one non-transitory computer-readable memory storing instructions, which, when executed by the at least one CPU, cause the electronic device to: receive, from a web server associated with a given webpage, a given web content to be rendered thereon in the browser application; execute a first rendering phase, during which the browser application is configured to: render the given web content by executing the first rendering pipeline using currently available computational resources of the at least one CPU; and initialize the GPU for rendering the given content; in response to receiving an indication of the GPU having been initialized, execute a second rendering phase following the first rendering phase, during which the browser application is configured to: execute a hot switch from the first rendering pipeline to the second rendering pipeline to continue rendering the given content of the given webpage using the GPU; and display the given webpage with the given content rendered thereon on a screen of the electronic device.

In some implementations of the electronic device, to render the given web content by executing the first rendering pipeline, the browser application is configured to initialize the at least one CPU for the rendering by uploading a first set of instructions therefor to a random-access memory (RAM) of the electronic device, the first set of instructions being able to be uploaded to the RAM over a first period; and to initialize the GPU, the browser application is configured to upload a second set of instructions for the GPU to the RAM of the electronic device, the second set of instructions being able to be uploaded to the RAM over a second period, greater than the first period.

In some implementations of the electronic device, the first set of instructions is smaller in size than the second set of instructions.

In some implementations of the electronic device, the second set of instructions comprises instructions to initialize a context of the GPU.

In some implementations of the electronic device, to execute the host switch, the browser application is configured to abort executing the first rendering pipeline.

In some implementations of the electronic device, to abort executing the first rendering pipeline, the browser application is configured to unload the first set of instructions from the RAM of the electronic device.

In some implementations of the electronic device, the browser architecture of the browser application is based on a Chromium browser architecture.

In some implementations of the electronic device, the instructions cause the electronic device to execute the first and second rendering phases during a cold start of the browser application.

In some implementations of the electronic device, the executing the first rendering pipeline comprises causing an operating system (OS) of the electronic device to execute a first operating system (OS) process; and the executing the second rendering pipeline comprises causing the OS of the electronic device to execute a second OS process, different from the first OS process.

In some implementations of the electronic device, to execute the hot switch, the browser application is configured to cause the operating system to end the first OS process and run the second OS process.

In the context of the present specification, a “server” is a computer program that is running on appropriate hardware and is capable of receiving requests (for example from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (for example received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus, information includes, but is not limited to visual works (for example maps), audiovisual works (for example images, movies, sound records, presentations etc.), data (for example location data, weather data, traffic data, numerical data, etc.), text (for example opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system configurable for implementing certain non-limiting embodiments of the present technology;

FIG. 2 depicts a schematic diagram of a networked computing environment comprising the computer system of FIG. 1 and being suitable for use with certain non-limiting embodiments of the present technology;

FIG. 3 depicts a schematic diagram of a graphical user interface (GUI) of a browser application run on an electronic device present in the networked computing environment of FIG. 2 and providing a visual representation of a given web page, in accordance with certain non-limiting embodiments of the present technology;

FIG. 4 depicts a schematic diagram of a first and second rendering pipelines executed by the browser application run on the electronic device present in the networked computing environment of FIG. 2 for rendering web content of the given web page, in accordance with certain non-limiting embodiments of the present technology;

FIG. 5 depicts a time diagram of the browser application run on the electronic device present in the networked computing environment of FIG. 2 executing the first and second rendering pipelines, in accordance with certain non-limiting embodiments of the present technology; and

FIG. 6 depicts a flowchart diagram of a method for rendering the web content in the browser application, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

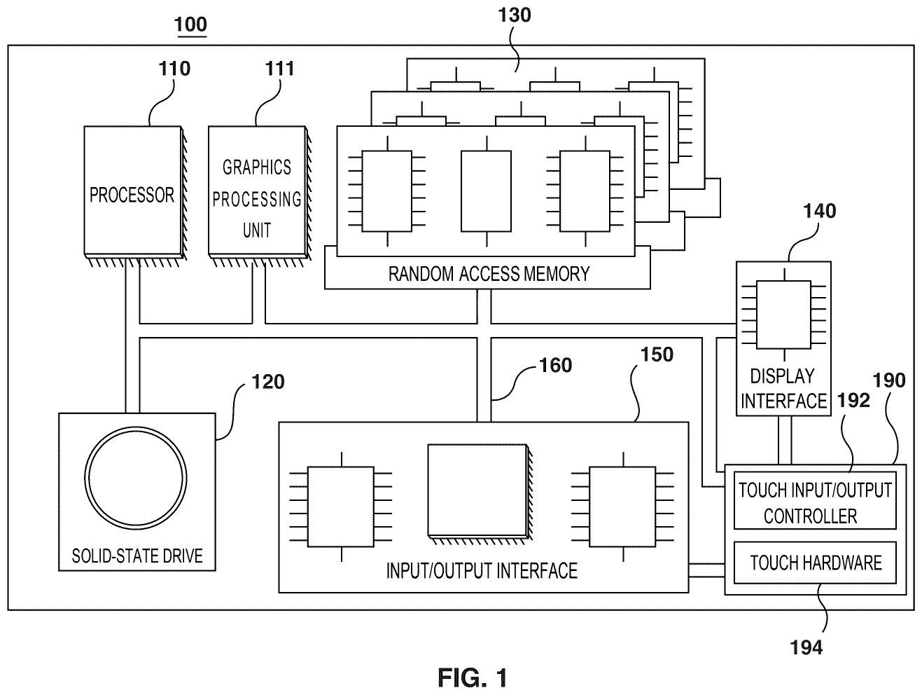

With reference to FIG. 1, there is depicted a computer system 100 suitable for use with some implementations of the present technology. The computer system 100 comprises various hardware components including one or more single or multi-core processors collectively represented by a central processing unit (CPU) 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (for example a PCI bus, universal serial bus, IEEE 1394 “Firewire” bus, SCSI bus, Serial-ATA bus, etc.), to which the various hardware components are electronically coupled.

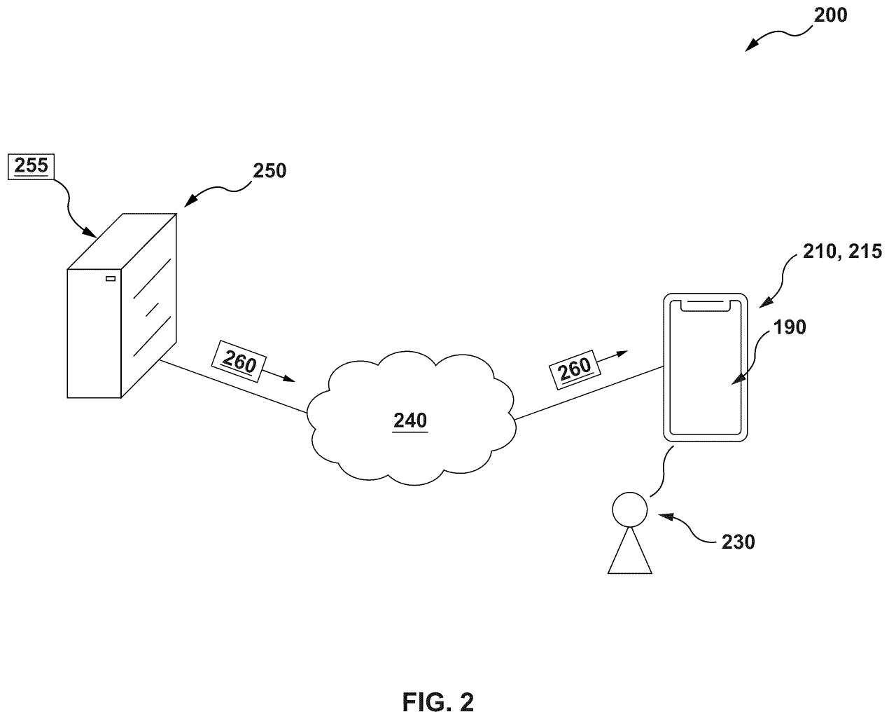

The input/output interface 150 may be coupled to a screen 190 and/or to the one or more internal and/or external buses 160. In some non-limiting embodiments of the present technology, the screen 190 of the computer system 100 can be implemented as a touchscreen—such as that of an electronic device 210 depicted in FIG. 2. In these embodiments, the screen 190 comprises touch hardware 194 (for example, pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the screen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the CPU 110 and/or the GPU 111. For example, the program instructions may be part of a library or an application.

### Networked Computing Environment

With reference to FIG. 2, there is depicted a networked computing environment 200 suitable for use with some non-limiting embodiments of the present technology. The networked computing environment 200 includes an electronic device 210 communicatively coupled, via a communication network 240, with a server 250. In some non-limiting embodiments of the present technology, the electronic device 210 may be associated with a user 230.

In the non-limiting embodiments of the present technology, the electronic device 210 may be any computer hardware that is capable of running a software appropriate to the relevant task at hand. Thus, some non-limiting examples of the electronic device 210 may include personal computers (desktops, laptops, netbooks, etc.), smartphones, and tablets. Thus, the electronic device 210 may comprise some or all components of the computer system 100 depicted in FIG. 1.

In some non-limiting embodiments of the present technology, the server 250 can be implemented as a conventional computer server and may comprise some or all of the components of the computer system 100 of FIG. 1. In one non-limiting example, the server 250 is implemented as a Dell™ PowerEdge™ Server running the Microsoft™ Windows Server™ operating system but can also be implemented in any other suitable hardware, software, and/or firmware, or a combination thereof. In the depicted non-limiting embodiments of the present technology, the server 250 is a single server. In alternative non-limiting embodiments of the present technology (not depicted), the functionality of the server 250 may be distributed and may be implemented via multiple servers.

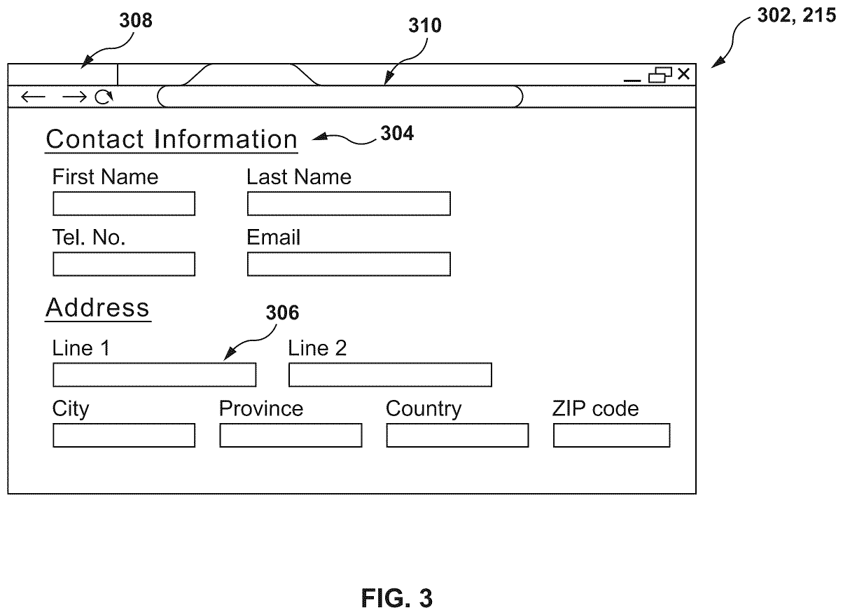

According to some non-limiting embodiments of the present technology, the server 250 can be configured to host a given web resource 255. Broadly speaking, the given web resource 255 may contain and thus provide access to information of various types, such as texts, images, audio, and video organized in at least one web page (such as a given web page 302 depicted in FIG. 3) that is identifiable, in the communication network 240, using, for example, a respective Unique Resource Locator (URL) associated with the at least one page. One of examples of the given web resource 255 may include, without limitation, a web site, such as a commercial web site aimed at promoting certain goods, a social network (such as for example, Facebook.com™), an online video service (for example, Kinopoisk.ru™), and the like.

Thus, in some non-limiting embodiments of the present technology, the user 230, using the electronic device 210, may request access to the given web page 302, such as by submitting the associated URL to an address bar (such an address bar 310 depicted in FIG. 3) of a browser application 215 running on the electronic device 210. In another example, the user 230 can be redirected to the given web page 302 from another web page including a respective reference to the given web page 302, on which the user 230 has clicked, as an example.

In yet other example, the URL associated with the given web page 302 could be stored by the browser application 215 from one of previous browsing sessions can therefore be submitted automatically at a start of a new browsing session of the browser application 215. For example, the new browsing session can be initiated by a new start of the browsing application 215 following closing the browser application 215 including ending all processes associated therewith in an operating system (OS) of the electronic device 210. For example, the new browsing session can be initiated by opening the browser application 215 after a reboot of the OS of the electron device 215. In this case, opening the browser application can be referred to as a “cold start” thereof.

In the context of the present specification, the browser application 215 can be a software application run on an electronic device, such as the electronic device 210, and configured to provide access to resources of nodes of a given network, such as those of the communication network 240, in response to receiving respective network addresses thereof in the given network. In a specific non-limiting example, the browser application 215 can be implemented as a Yadex.Browser™ browser application provided by Yandex LLC of Lev Tolstoy Street, No. 16, Moscow, 119021, Russia.

Further, in response to the user 230 submitting the URL associated with the given web page 302, the server 250 can be configured to grant access to the electronic device 210 to the given web page 302 of the given web resource 255 by transmitting a data packet 260. The data packet 260 can include an executable source code, such as that developed in HyperText Markup Language (HTML). However, in other non-limiting embodiments of the present technology, at least a portion of the executable source code can be developed in a different programming language—such as at least one a JavaScript programming language and a Cascading Style Sheets (CSS) programming language.

Further, according to certain non-limiting embodiments of the present technology, the data packet 260 can include web content defining a visual representation of the given web page 302. Further, the electronic device 210 causes the browser application 215 to render the web content on the screen 190 of the electronic device 210 for presentation of the given web page 302 to the user 230.

Thus, having received this data packet 260, the browser application 215 of the electronic device 210 can be caused to execute the executable source code associated with the given web page 302, thereby rendering, such as by a rendering engine of the browser application 215, the web content of the given web page 302 on the screen 190 of the electronic device 210 for presentation of the given web page 302 to the user 230.

With reference to FIG. 3, there is depicted a graphical user interface of the browser application 215 providing the visual representation of the given web page 302, in accordance with certain non-limiting embodiments of the present technology.

As it can be appreciated from FIG. 3, according to certain non-limiting embodiments of the present technology, the content rendered on the given web page 302 can include a plurality of layout elements defining the visual representation thereof. Non-limiting examples of such layout elements can include, for example: text boxes including text content, such as a first layout element 304; activatable layout elements including JavaScript and CSS activatable layout elements, such as a second layout element 306 configured for providing customized suggests in response to certain user interactions therewith of the user 230. Other examples of the activatable layout elements are not limited and, depending on a subject matter present in the given web page 302, can include checkboxes, radio buttons, dropdown menus, and other interactive web elements whose visual appearance can be changed in response to the user inputs of the user 230.

Also, in some non-limiting embodiments of the present technology, the plurality of layout elements of the given web page 302 can include layout elements (not depicted) that are configured to accommodate media content, such as one of image, audio, and video content. For example, the plurality of layout elements can include a video player (not depicted) for playing back certain video content, such as a clip, a movie, and the like. Formats of the video content are also not limited and can include: MP4, MOV, AVI, WMV, and others. In another example, the plurality of layout elements can include an audio player configured, for example, to play back certain audio content, such as a background audio content or sounds responsive to certain user actions with other layout elements on the given web page 302, such as clicks, as an example. Formats of the audio content to be provided on the given web page 302 are also not limited and can include: MP3, Ogg, AAC, WAV, and others. In yet another example, the plurality of layout elements of the given web page 302 can include layout elements (not depicted) dedicated for rendering image content, including background image of the given web page 302 as well as images inserted therein. Formats of the image content is also not limited and can include, for example, JPEG, PNG, TIFF, GIFF, BMP, and others.

Also, as it can be appreciated from FIG. 3, aside from the plurality of layout elements of the given web page 302, in some non-limiting embodiments of the present technology, the web content to be rendered on the given web page 302 can include graphical user interface (GUI) elements of the browser application 215 that are rendered prior to rendering the given web page 302. For example, the GUI elements of the browser application 215 can include actuators 308 including a backward navigation button, a forward navigation button, and a refresh button. Also, the GUI elements of the browser application 215 to be rendered may include the address bar 310. Other GUI elements of the browser application 215 that can be rendered on the screen 190 of the electronic device 210 prior to the rendering the web content of the given web page 302 are also envisioned without departing from the scope of the present technology.

To render the given web page 302 on the screen 190 of the electronic device 210, the rendering engine of the browser application 215 can be configured to execute a rendering pipeline that is configured to render the web content of the given web page 302 on the screen 190 of the electronic device 210 as the rendering engine execute the executable source code of the given web page 302. Broadly speaking, the rendering pipeline can include: (i) downloading the data packet 260 from the server 250 to a memory of the electronic device 210, such as the solid-state drive 120 of the computer system 100; (ii) copying the web content of the given web page to a RAM of the electronic device 210, such as the RAM 130 of the computer system 100; and (iii) cause a processor of the electronic device, such as one the CPU 110 and the GPU 111 of the computer system 100, to render, from the RAM 130, the web content of the give web page 302 on the screen 190 of the electronic device 210.

Conventionally, the rendering engine is configured to execute a single rendering pipeline that uses computational resources of only one of the CPU 110 and GPU 111 for rendering content of the given web page 302. However, this may be associated with certain challenges. More specifically, although the CPU 110 has a direct access to the solid-state drive 120 and RAM 130 and can hence handle rendering larger and more complex portions of the web content, the CPU 110 may be rendering with perceivable delays as it may lack sufficient computational resources allocated for the rendering. Accordingly, this problem can be even more exacerbated when the web content includes so-called “heavy” content, requiring more space in the RAM 130, such as the video content or high-resolution (HD) image content.

On the other hand, the GPU 111 may allow for more available computational resources for the rendering the web content, which makes the GPU 111 more suitable for rendering high-quality graphic web content. However, initialization of the GPU 111 for the rendering the web content of the given web page 302, especially, during the “cold” start of the browser application 215, may take significant time, which may also cause user-perceivable delays to the user 230. Thus, using only one of the CPU 110 and the GPU 111 may affect the user-experience of the user 230 from interacting with either one or both of the browser application 215 or an entity associated with the given web page 302, such as that owning the given web resource 255.

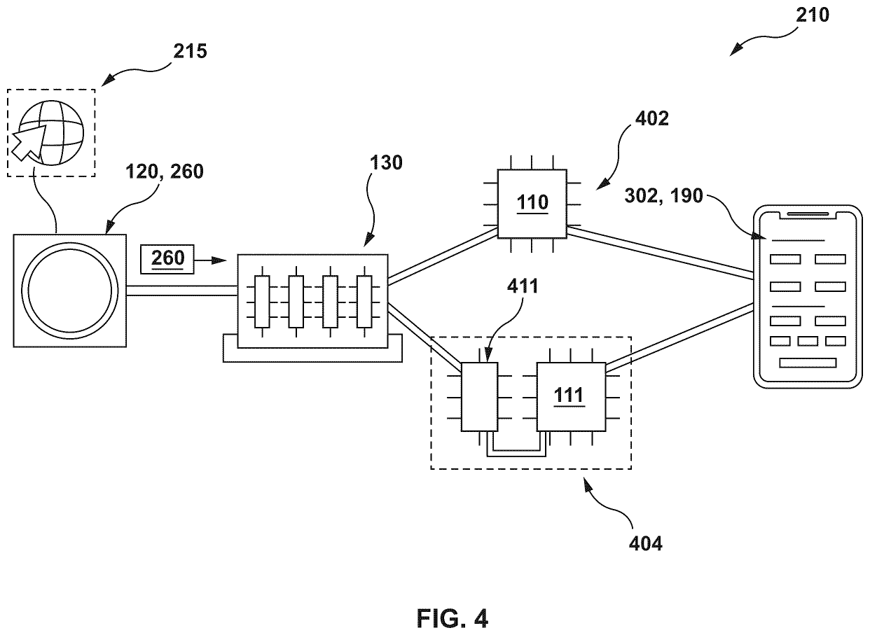

Therefore, the developers of the present technology have developed methods and systems enabling the rendering engine of the browser application 215 to execute two independent rendering pipelines. A first rendering pipeline (such as a first rendering pipeline 402 of FIG. 4) can be configured for rendering the web content using the computational resources of the CPU 110, whereas a second rendering pipeline (such as a second rendering pipeline 404 of FIG. 4) can be configured for rendering the web content using the computational resources of the GPU 111. As initialization of the CPU 110 for the rendering of the web content may take comparatively less time than that of the GPU 111, while the rendering engine of the browser application 215 executes the first rendering pipeline 402 using the resources of the CPU 110, the rendering engine can be configured to start initialization of the GPU 111 for preparing the second rendering pipeline 404. Once the GPU 111 is initialized, the rendering engine of the browsing application 215 can be configured to execute a “hot” switch from the first rendering pipeline 402 to the second rendering pipeline 404 to continue rendering the web content on the screen 190 of the electronic device 210.

By doing so, the present methods and systems may allow reducing the aforementioned user-perceivable delays of the user 230 during the rendering of the given web page 302, which may help improve the user experience from interacting with the browser application 215 or the given web resource 255.

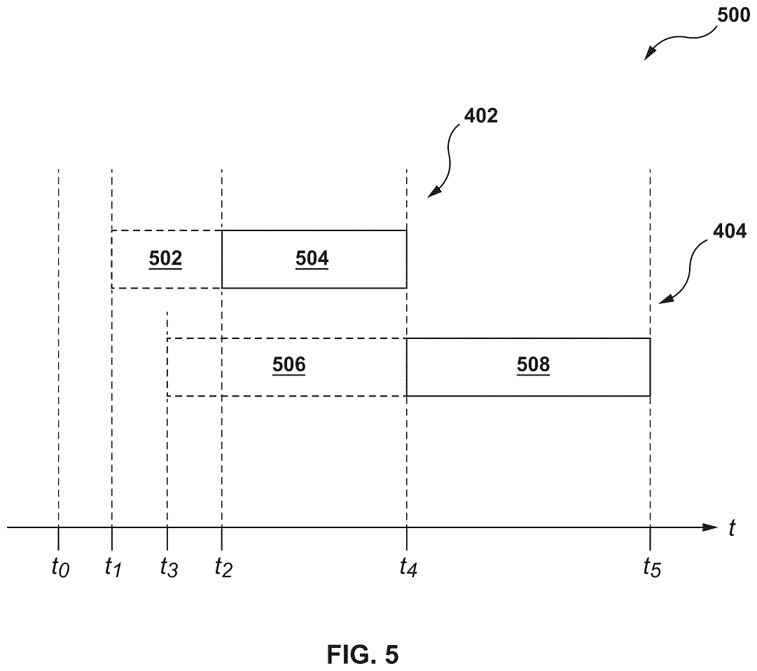

How the architecture of the rendering engine of the browser application 215, defining two rendering pipelines is implemented, in accordance with certain non-limiting embodiments of the present technology, will be described below with reference to FIGS. 4 and 5.

### Communication Network

In some non-limiting embodiments of the present technology, the communication network 240 is the Internet. In alternative non-limiting embodiments of the present technology, the communication network 240 can be implemented as any suitable local area network (LAN), wide area network (WAN), a private communication network, or the like. It should be expressly understood that implementations for the communication network are for illustration purposes only. How a respective communication link (not separately numbered) between each one of the electronic device 210, the server 250 and the communication network 240 is implemented will depend, inter alia, on how each one of electronic device 210, and the server 250 is implemented. Merely as an example and not as a limitation, in those embodiments of the present technology where the electronic device 210 is implemented as a wireless communication device such as the smartphone, the communication link can be implemented as a wireless communication link. Examples of wireless communication links include, but are not limited to, a 3G communication network link, a 4G communication network link, and the like. The communication network 240 may also use a wireless connection with the server 250 and the electronic device 210.

### Rendering Engine Architecture

As mentioned herein above, to render the web content associated with the given web the given web page 302 to the address bar 310 of the browser application, according to certain non-limiting embodiments of the present technology, first, the CPU 110 of the electronic device 210 can be configured to download, to the solid-state drive 120, the data packet 260 including the executable source code associated with the given web page 302 and the web content thereof to be rendered on the screen 190 by executing the executable source code. Further, according to certain non-limiting embodiments of the present technology, the CPU 110 can be configured to: (i) cause the rendering engine to execute the executable source code associated with given web page 302 to the RAM 130 and (ii) cause the rendering engine of the browser application 215 to render the web content on the screen 190.

With reference to FIG. 4, there is depicted a schematic diagram of the first rendering pipeline 402 and the second rendering pipeline 404 of the browser application 215, in accordance with certain non-limiting embodiments of the present technology.

For rendering the web content, according to certain non-limiting embodiments of the present technology, an architecture of the browser application 215 can include two separate rendering pipelines: the first rendering pipeline 402 and the second rendering pipeline 404, each of which the rendering engine of the browser application 215 could be configured to execute. In a specific non-limiting example, the architecture of the browser application 215 can be based on, for example, a Chromium™ browser architecture.

According to certain non-limiting embodiments of the present technology, the first rendering pipeline 402 can include: (i) initializing the CPU 110 for rendering the web content; and (ii) using the currently available computational resources of the CPU 110, rendering the web content on the screen 190 of the electronic device 210. According to certain non-limiting embodiments of the present technology, initializing the CPU 110 can include causing uploading to the RAM 130 a first set of instructions including specific dynamic link library (DLL) files configured to cause the CPU 110 to execute the rendering. However, the developers of the present technology have appreciated that, in at least some non-limiting embodiments of the present technology, initialization of the CPU 110 could be omitted, thereby allowing for even faster rendering of the given web page 302.

According to certain non-limiting embodiments of the present technology, when the rendering engine starts executing the first rendering pipeline 402, the CPU 110 can be configured to cause the OS of the electronic device 210 to run a first OS process corresponding to the rendering the web content using the CPU 110. More specifically, if the browser application 215 is implemented based on the Chromium™ browser architecture, the first OS process can comprise a first browser.exe OS process associated with the browser application 215 in a command line of which there is an indication of using the computational resources of the CPU 110.

For example, a command line of the first browser.exe OS process can read: ‘browser.exe--type=gpu-process--user-id=<user_id>--brand-id=yandex--no-appcompat-clear--gpu-preferences=<base64_encoded_gpu_preferences>==--use-g1=disabled--gpu-process-kind=trampoline--field-trial-handle=<field_trial_handle>--enable-features=InstallerNewIdentity2024--variations-seed-version--mojo-platform-channel-handle=<channel_handle>/prefetch: 6’.

According to certain non-limiting embodiments of the present technology, the second rendering pipeline 404 can include: (i) initializing the GPU 111 for rendering the web content; (ii) transmitting the web content of the given web page 302 to the RAM 130; (iii) transmitting the web content of the given web page 302 from the RAM 130 to a video RAM (VRAM) 411 of the GPU 111; and (iv) using the currently available computational resources of the GPU 111, rendering the web content on the screen 190 of the electronic device 210. According to certain non-limiting embodiments of the present technology, when the rendering engine starts executing the second rendering pipeline 404, the CPU 110 can be configured to cause the OS of the electronic device 210 to run a second OS process corresponding to the rendering the web content using the GPU 111. More specifically, if the browser application 215 is implemented based on the Chromium™ browser architecture, the second OS process can comprise a second browser.exe OS process, different from the first browser.exe OS process, associated with the browser application 215 in a command line of which there is an indication of using the computational resources of the GPU 111.

For example, a command line of the second browser.exe OS process can read: ‘browser.exe--type=gpu-process--user-id=<user_id>--brand-id=yandex--no-appcompat-clear--gpu-preferences=<base64_encoded_gpu_preferences>==--gpu-process-kind=sandboxed--field-trial-handle=<field_trial_handle>--enable-features=InstallerNewIdentity2024--variations-seed-version--mojo-platform-channel-handle=<channel_handle>/prefetch:2’.

According to certain non-limiting embodiments of the present technology, initialization of the GPU 111 for the rendering of the web content can include causing the CPU 110 to upload, to the RAM 130, a second set of instructions, including: (i) specific DLL files configured to cause the GPU to execute the rendering of the web content; and (ii) instructions for initializing a GPU context of the GPU 111 for executing the task for the rendering.

More specifically, according to certain non-limiting embodiments of the present technology, the DLL files of the second set of instructions that the CPU 110 uploads to the RAM 130 for initializing the GPU 111 can include DLLs that are associated with Application Programming Interfaces (APIs) for hardware-accelerated rendering. In a specific non-limiting example, the DLLs files can include at least the following: d3dcompiler_47.dll, dxcompiler.dll, dxil.dll (DirectX™ shader compilers); libEGL.dll, libGLESv2.dll (OpenGL™ call translators); vkswiftshader.dll; DLLs of graphics drivers, such as igd10iumd64.dll for GPUs produced by Intel™; and others.

In the context of the present specification, the term “GPU context”, such as that of the GPU 111 collectively represents all data, variables, and conditions defining a state of the GPU 111 for executing the rendering the web content. More specifically, according to certain non-limiting embodiments of the present technology, the context of the GPU 111 defines the state of the GPU 111 for executing web content rendering tasks, including, without limitation: an animate rendering task; a style rendering task; a layout rendering task; pre-paint rendering task; a scroll rendering task; a paint rendering task; a commit rendering task; a layerize rendering task; an activate rendering task, an aggregate rendering task, and a draw rendering task. More details on how these rendering tasks are executed and what they comprise can be found in an article entitled “RenderingNG Architecture,” authored by Chris Harrelson, and published under developer.chrome.com/docs/chromium/renderingng-architecture?hl=en, content of which is incorporated by reference in its entirety.

As will become apparent from the description provided below, the first set of instructions for initializing the CPU 110 can be smaller in size than the second set of instructions for initializing the GPU 111. Thus, in some non-limiting embodiments of the present technology, the rendering engine can be configured to initialize the CPU 110 faster than the GPU 111.

Further, as mentioned hereinabove, in some non-limiting embodiments of the present technology, to render the web content of the given web page 302 in the screen 190 of the electronic device 210, the rendering engine of the browser application 215 can be configured to combine execution of both the first and second rendering pipelines 402, 404.

With reference to FIG. 5, there is depicted a time diagram 500 of the rendering engine executing the first and second rendering pipelines 402, 404, in accordance with certain non-limiting embodiments of the present technology.

Let it be assumed that, at an initial moment in time t₀, the user 230 submitted the URL associated with the given web page 302 to the address bar 310 of the browser application 215, thereby requesting from the server 250 the data packet 260. In response to receiving the data packet 260, the rendering engine can be configured to cause execution of the executable source code of the given web page 302. First, according to certain non-limiting embodiments of the present technology, the rendering engine can be configured to execute the first rendering pipeline 402, causing the CPU 110 to cause the OS to run the first OS process associated with the first rendering pipeline 402. To that end, at a first moment in time t₁, during a first initialization period 502, the rendering engine can be configured to cause initialization of the CPU 110 for the rendering the web content in the data packet 260 by causing uploading to the RAM 130 the first set of instructions, as mentioned above. Further, once the CPU 110 has been initialized, at a second moment in time t₂ and during a first rendering period 504, the rendering engine can be configured to cause the CPU 110 to render the web content of the given web page 110 on the screen 190 of the electronic device 210.

As noted hereinabove, in some non-limiting embodiments of the present technology, the rendering engine can be configured to omit the initialization of the CPU 110, in which case, the rendering engine can be configured to render the web content from the second moment in time 12.

During the execution of the first rendering pipeline 402, at a third moment in time t₃, the rendering engine can be configured to start executing the second rendering pipeline 404, thereby causing the CPU 110 to cause the OS of the electronic device 210 to run the second OS process associated with the second rendering pipeline 404.

In some non-limiting embodiments of the present technology, the third moment in time can coincide with the first moment in time, that is, the rendering engine can be configured to launch the execution of both the first and second rendering pipelines 402, 404 simultaneously. In some non-limiting embodiments of the present technology, the third moment in time can coincide with the second moment in time, that is, the rendering engine can be configured to start executing the second rendering pipeline 404 and cause the CPU 110 to render the web content substantially simultaneously. In other non-limiting embodiments of the present technology, as schematically depicted in the time diagram 500, the third moment in time can be between the first and second moments in time, that is, during the first initialization period 502 of the CPU 110. In yet other non-limiting embodiments of the present technology, the rendering engine can be configured to start executing the second rendering pipeline 404 at the third moment in time that is after the second moment in time, that is, during the first rendering period 504.

At the third moment in time, during a second initialization period 506, according to certain non-limiting embodiments of the present technology, the rendering engine can be configured to cause initialization of the GPU 111 for the rendering of the web content by causing uploading to the RAM the second set of instructions. As mentioned hereinabove, the initialization of the GPU 111 for the rendering can include transmitting certain DLLs to the RAM 130 and initialization of the CPU context of the GPU 111 for the rendering the web content.

Further, once the second initialization period 504 ends at a fourth moment in time t₄, according to certain non-limiting embodiments of the present technology, the rendering engine can be configured to execute the hot switch from the first rendering pipeline 402 to the second rendering pipeline 404. More specifically, once the rendering engine has determined that the GPU 111 is initialized and ready for the rendering of the web content, according to certain non-limiting embodiments of the present technology, the rendering engine can be configured to: (i) abort executing the first rendering pipeline 402 for the rendering of the web content, thereby ending the first rendering period 504, and (ii) begin a second rendering period 508, during which the rendering engine can be configured to continue rendering the web content o the given web page 302 using the currently available resources of the GPU 111. By doing so, the rendering engine can be configured to cause the CPU 110 to (i) end, in the OS of the electronic device 210, the first OS process associated with the first rendering pipeline 402, and (ii) use only the second OS process, associated with the second rendering pipeline 404, for further rendering of the web content of the given web page 302.

It is not limited how the rendering engine is configured to determine that the GPU 111 is initialized for rendering and can include, in some non-limiting embodiments of the present technology, receiving a flag indicative of the GPU context of the GPU 111 having been initialized.

Thus, executing the second rendering pipeline 404, the rendering engine can be configured to cause the GPU 111 to render the web content on the screen 190 of the electronic device 210 during the second rendering period 508 until a fifth moment in time t₅ when the web content of the given web page 302 is fully rendered. Once the web content of the given web page 302 is fully rendered, according to certain non-limiting embodiments of the present technology, the rendering engine can be configured to cause display of the given web page to the user 230.

However, in other non-limiting embodiments of the present technology, the rendering engine can be configured to cause display of the web content of the given web page 302 in real time, as it is being rendered.

Thus, as the first set of instructions for initializing the CPU 110 is smaller in size than the second set of instructions for initializing the GPU 111, allowing for faster initialization of the CPU 110 compared to the GPU 111, by using at leas some non-limiting embodiments of the present technology, the rendering engine can be configured to start rendering the web content of the given web page 302 sooner than when using the GPU 111 alone. Also, as using only the CPU 110 for the rendering of the web content, especially “heavier” elements thereof (such as video, HD images, or 3D models), can be a very computational extensive task for the CPU 110, using both the first and second rendering pipelines 402, 404 for the rendering may allow balancing the computational burden of the rendering between the CPU 110 and GPU 111. For example, using the present methods and systems, by executing the first rendering pipeline 402, the rendering engine can be configured to start rendering the web content with “lighter” elements thereof, such as GUI elements of the browser application 215, text content of the given web page 302 and lower-quality graphics, for example, causing, at the same time, the initialization of the GPU 111. Further, once the GPU 111 is initialized, the rendering engine can be configured to use the second rendering pipeline 404 for to continue rendering the web content by rendering the “heavier” elements thereof using the GPU 111.

Thus, the present methods and systems may help reduce the user-perceivable delays during the rendering of the web content, which can enhance the user experience of the user 230 from interacting with the browser application 215 and the given web resource 255 including the given web page 302.

### Method

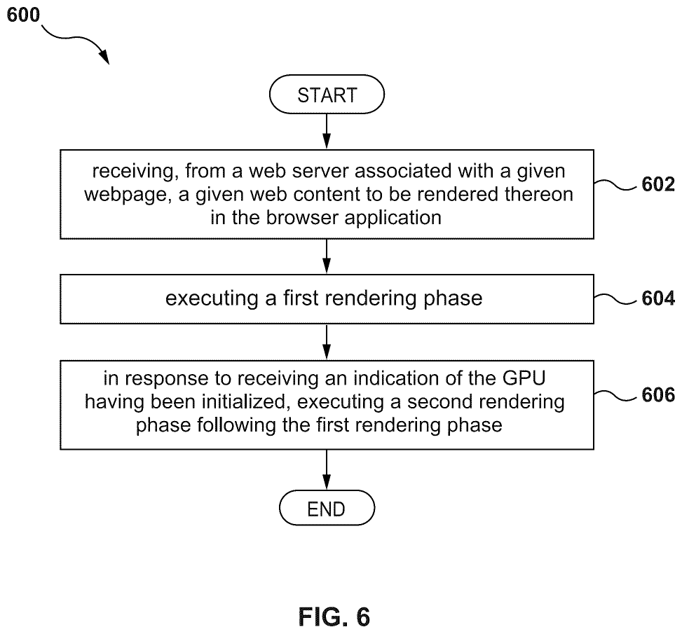

Given the architecture and examples provided hereinabove, it is now possible to execute a method for rendering a web content in a browser application, such as the web content of the given web page 302 in the browser application 215 described above. With reference to FIG. 6, there is depicted a flowchart diagram of a method 600, in accordance with certain non-limiting embodiments of the present technology. The method 600 can be executed, for example, the CPU 110 of the electronic device 210.

### Step 602: Receiving, From a Web Server Associated With a Given Webpage, a Given Web Content to be Rendered Thereon in the Browser Application

The method 600 commences at step 602 with the CPU 110 being configured to receive, from the server 250 hosting the given web resource 255, the data packet 260 including the executable source code and the web content of the given web page to be rendered. As mentioned hereinabove, the CPU 110 can be configured to receive the data packet 260 in response to the URL associated with the given web page 302 being submitted to the address bar 310 of the browser application 215, such as during the cold start of the browser application or by the user 230.

Once the CPU 110 has received the data packet 260, the CPU 110 can be configured to cause the rendering engine of the browser application 215 to execute the executable source code of the given web page 302, thereby causing the rendering engine to render the web content thereof. According to certain non-limiting embodiments of the present technology, the rendering engine can be configured to render the web content of the given web page in two rendering phases that are described hereinbelow.

The method 600 hence advances to step 604.

### Step 604: Executing a First Rendering Phase

At step 604, according to certain non-limiting embodiments of the present technology, the CPU 110 can be configured to cause the rendering engine of the browser application 215 to execute a first rendering phase of the web content associated with the given web page 302. More specifically, the CPU 110 can be configured to cause the rendering engine to: (i) to start executing the first rendering pipeline 402 for rendering the web content using the CPU 110; and (ii) cause initialization of the GPU for executing the second rendering pipeline 404.

As described in detail above with reference to FIGS. 4 and 5, to execute the first rendering pipeline 402, the rendering engine can be configured to: (i) cause the CPU 110 to upload, to the RAM 130, the first set of instructions for initializing the CPU 110 for the rendering the web content during the first initialization period 502; and (ii) cause the CPU 110 to render the web content at the second moment in time, once the CPU 110 is initialized, during the first rendering period 504. To do so, in some non-limiting embodiments of the present technology, the rendering engine can be configured to cause the OS of the electronic device 210 to run the first OS process associated with the first rendering pipeline 402.

Further, during the execution of the first rendering pipeline 402, that is, during one of the first initialization period 502 and the first rendering period 504, at the third moment in time, the rendering engine can be configured to start executing the second rendering pipeline 404 by causing, during the second initialization period 506, the CPU 110 to upload, to the RAM 130, the second set of instructions for initializing the GPU 111 for the rendering. To do so, akin to the first rendering pipeline, the rendering engine can be configured to cause the OS of the electronic device 210 to run the second OS process associated with the second rendering pipeline 404.

The method 600 hence advances to step 606.

Step 606: In Response to Receiving an Indication of the GPU Having Been Initialized, Executing a Second Rendering Phase Following the First Rendering Phase

At step 606, in response to determining that the GPU 111 is initialized, according to certain non-limiting embodiments of the present technology, at the fourth moment in time, the rendering engine can be configured to end the first rendering phase and execute a second rendering phase. More specifically, during the second rendering phase, the rendering engine can be configured to execute the hot switch from the first rendering pipeline 402 to the second rendering pipeline 404, continuing rendering the web content of the given web page 302 using the GPU 111. To do so, according to certain non-limiting embodiments of the present technology, the rendering engine can be configured to cause the CPU 110 to cause the OS of the electronic device 210 to end the first OS process and use for the rendering of the web content of the given web page only the second OS process, associated with the second rendering pipeline 404.

Further, after fully rendering the web contend of the given web page 302 on the screen 190 of the electronic device 20, the rendering engine can be configured to display the given web page 302 to the user 230.

The method 600 hence terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implemented method for rendering web content in a browser application, executed by an electronic device comprising a central processing unit (CPU) and a graphics processing unit (GPU), the browser application having: (i) a first rendering pipeline for rendering the web content using the CPU, and (ii) a second rendering pipeline for rendering the web content using the GPU, the method comprising:
receiving, from a web server associated with a given webpage, a given web content to be rendered thereon in the browser application;
executing a first rendering phase, during which the browser application is configured to:
render the given web content by executing the first rendering pipeline using currently available computational resources of the CPU; and
initialize the GPU for rendering the given content;
in response to receiving an indication of the GPU having been initialized, executing a second rendering phase following the first rendering phase, during which the browser application is configured to:
execute a hot switch from the first rendering pipeline to the second rendering pipeline to continue rendering the given content of the given webpage using the GPU; and
display the given webpage with the given content rendered thereon on a screen of the electronic device.

2. The method of claim 1, wherein:
to render the given web content by executing the first rendering pipeline, the browser application is configured to initialize the CPU for the rendering by uploading a first set of instructions therefor to a random-access memory (RAM) of the electronic device,
the first set of instructions being able to be uploaded to the RAM over a first period; and to initialize the GPU, the browser application is configured to upload a second set of instructions for the GPU to the RAM of the electronic device,
the second set of instructions being able to be uploaded to the RAM over a second period, greater than the first period.

3. The method of claim 2, wherein the first set of instructions is smaller in size than the second set of instructions.

4. The method of claim 2, wherein the second set of instructions comprises instructions to initialize a context of the GPU.

5. The method of claim 1, wherein to execute the host switch, the browser application is configured to abort executing the first rendering pipeline.

6. The method of claim 5, wherein to abort executing the first rendering pipeline, the browser application is configured to unload the first set of instructions from the RAM of the electronic device.

7. The method of claim 1, wherein the browser architecture of the browser application is based on a Chromium browser architecture.

8. The method of claim 1, wherein the method is executed during a cold start of the browser application.

9. The method of claim 1, wherein:
the executing the first rendering pipeline comprises causing an operating system (OS) of the electronic device to execute a first operating system (OS) process; and
the executing the second rendering pipeline comprises causing the OS of the electronic device to execute a second OS process, different from the first OS process.

10. The method of claim 9, wherein to execute the hot switch, the browser application is configured to cause the operating system to end the first OS process and run the second OS process.

11. An electronic device for rendering web content in a browser application, executed by the electronic device, the electronic device comprising: at least one central processing unit (CPU) and a graphics processing unit (GPU),
the browser application having: (i) a first rendering pipeline for rendering the web content using the at least one CPU, and (ii) a second rendering pipeline for rendering the web content using the GPU;
the electronic device further comprising at least one non-transitory computer-readable memory storing instructions, which, when executed by the at least one CPU, cause the electronic device to:
receive, from a web server associated with a given webpage, a given web content to be rendered thereon in the browser application;
execute a first rendering phase, during which the browser application is configured to:
render the given web content by executing the first rendering pipeline using currently available computational resources of the at least one CPU; and
initialize the GPU for rendering the given content;
in response to receiving an indication of the GPU having been initialized, execute a second rendering phase following the first rendering phase, during which the browser application is configured to:
execute a hot switch from the first rendering pipeline to the second rendering pipeline to continue rendering the given content of the given webpage using the GPU; and
display the given webpage with the given content rendered thereon on a screen of the electronic device.

12. The electronic device of claim 11, wherein:
to render the given web content by executing the first rendering pipeline, the browser application is configured to initialize the at least one CPU for the rendering by uploading a first set of instructions therefor to a random-access memory (RAM) of the electronic device,
the first set of instructions being able to be uploaded to the RAM over a first period; and
to initialize the GPU, the browser application is configured to upload a second set of instructions for the GPU to the RAM of the electronic device,
the second set of instructions being able to be uploaded to the RAM over a second period, greater than the first period.

13. The electronic device of claim 12, wherein the first set of instructions is smaller in size than the second set of instructions.

14. The electronic device of claim 12, wherein the second set of instructions comprises instructions to initialize a context of the GPU.

15. The electronic device of claim 11, wherein to execute the host switch, the browser application is configured to abort executing the first rendering pipeline.

16. The electronic device of claim 15, wherein to abort executing the first rendering pipeline, the browser application is configured to unload the first set of instructions from the RAM of the electronic device.

17. The electronic device of claim 11, wherein the browser architecture of the browser application is based on a Chromium browser architecture.

18. The electronic device of claim 11, wherein the instructions cause the electronic device to execute the first and second rendering phases during a cold start of the browser application.

19. The electronic device of claim 11, wherein:
the executing the first rendering pipeline comprises causing an operating system (OS) of the electronic device to execute a first operating system (OS) process; and
the executing the second rendering pipeline comprises causing the OS of the electronic device to execute a second OS process, different from the first OS process.

20. The electronic device of claim 19, wherein to execute the hot switch, the browser application is configured to cause the operating system to end the first OS process and run the second OS process.
